(19) United States
(12) Patent Application Publication
(10) Pub. No.: US 2025/0348991 A1
(43) Pub. Date: Nov. 13, 2025

(54) METHOD FOR DETERMINING A QUALITY CHARACTERISTIC OF A WELDED CONNECTION BETWEEN TWO CONDUCTOR ENDS, METHOD FOR PROVIDING A TRAINING DATA RECORD, TRAINING DATA RECORD, METHOD FOR WELDING CONDUCTOR ENDS AND DEVICE FOR DETERMINING A QUALITY CHARACTERISTIC OF A WELDED CONNECTION

(71) Applicant: PRECITEC GMBH & CO. KG, GAGGENAU (DE)

(72) Inventors: MARKUS OMLOR, WUERZBURG (DE); JOHANNES REITH, STUTTGART (DE); FABIAN STEFFEN, KARLSRUHE (DE); JOACHIM SCHWARZ, KLEINANDELFINGEN (CH)

(73) Assignee: PRECITEC GMBH & CO. KG, GAGGENAU (DE)

(21) Appl. No.: 18/870,396

(22) PCT Filed: May 24, 2023
(86) PCT No.: PCT/EP2023/063948

§ 371 Date: Nov. 28, 2024

(30) Foreign Application Priority Data
May 31, 2022 (DE) 10 2022 113 705.8

(51) Int. Cl. G06T 7/00; B23K 26/21; B23K 31/12

(52) U.S. Cl. CPC G06T 7/0004; B23K 26/21; B23K 31/125; G06T 2207/10024; G06T 2207/10028; G06T 2207/20081; G06T 2207/20084; G06T 2207/30108; G06T 2207/30164

(57) ABSTRACT

A method for determining a quality criterion of a welded connection between two conductor ends. The method includes acquiring intensity information of a plurality of image points and depth information of the plurality of image points of an acquisition area covering the two conductor ends, and determining a quality criterion as a function of the intensity information acquired and the depth information acquired.

### CROSS REFERENCE TO PRIOR APPLICATIONS

This application is a U.S. National Phase application under 35 U.S.C. § 371 of International Application No. PCT/EP2023/063948, filed on May 24, 2023 and which claims benefit to German Patent Application No. 10 2022 113 705.8, filed on May 31, 2022. The International Application was published in German on Dec. 7, 2023 as WO 2023/232600 A1 under PCT Article 21(2).

### FIELD

The present invention refers to a method for determining a quality criterion of a welded connection between two conductor ends. The present invention also relates to a method for welding conductor ends. The present invention also relates to a method for providing a training data set for a machine learning system for determining a quality criterion of a welded connection between two conductor ends. The present invention also provides a training data set for a machine learning system for determining a quality criterion of a welded connection between two conductor ends. The present invention also provides a method for welding conductor ends. The present invention is also directed to a device for determining a quality criterion of a welded connection.

### BACKGROUND

Such welded connections are typically configured between two conductor ends of hairpin elements of an electric machine in order to join several hairpin elements, i.e., hairpin-shaped copper wires usually having a rectangular cross-section, to form a coil of the electric machine. An electric machine usually comprises a large number, often hundreds, of such welded connections.

The welded connections between the conductor ends are typically generated via a beam welding process, for example, via laser welding, and must fulfil certain quality requirements. It is, for example, necessary that the connection area, i.e., the cross-sectional area available for the current flow from one conductor to the other, is sufficiently large. A connection area which is too small can result in an undesirably high ohmic resistance and negatively affect the efficiency of the electric machine.

It is therefore necessary to check the quality of the welded connections. A method widely used in the state of the art involves determining the connection area using X-ray analysis. The joined contact zone of the two conductors is thereby placed in a corresponding device and X-rayed. This process involves great effort in terms of equipment and time.

### SUMMARY

An aspect of the present invention is to make possible the performance of a precise inspection of welded connections between conductor ends with a low temporal effort.

In an embodiment, the present invention provides a method for determining a quality criterion of a welded connection between two conductor ends. The method includes acquiring intensity information of a plurality of image points and depth information of the plurality of image points of an acquisition area covering the two conductor ends, and determining a quality criterion as a function of the intensity information acquired and the depth information acquired.

### BRIEF DESCRIPTION OF THE DRAWINGS

The present invention is described in greater detail below on the basis of embodiments and of the drawings in which:

FIG. 1 shows a schematic sequence of an embodiment of a method according to the present invention;

FIG. 2 shows an exemplary method for determining a quality criterion via machine learning;

FIG. 3 shows a further exemplary method for determining a quality criterion via machine learning; and

FIG. 4 shows a further exemplary method for determining a quality criterion via machine learning.

### DETAILED DESCRIPTION

The present invention provides a method for determining a quality criterion of a welded connection between two conductor ends, in particular between two conductor ends of hairpin elements of an electric machine, wherein,
at least intensity information of the image points and depth information of the image points are acquired for a plurality of image points of an acquisition area covering the conductor ends, and
a quality criterion, in particular a connection area or a pore volume, is determined as a function of the acquired intensity information and depth information.

The present invention also provides a device for determining a quality criterion of a welded connection between two conductor ends, in particular between two conductor ends of hairpin elements of an electric machine, the device having,
an image-acquisition device for acquiring intensity information for a plurality of image points of an acquisition area covering the conductor ends,
a depth-information acquisition device for acquiring depth information of the image points, and
a processor unit for determining a quality criterion, in particular a connection area or a pore volume, as a function of the acquired intensity information and depth information.

According to the method and device according to the present invention, intensity information and additional depth information are acquired for a plurality of image points of an acquisition area. The combination of this information makes it possible to derive a quality criterion of the welded connection between the conductor ends as a function of this information. The method can be carried out during the actual welding process or shortly after the welding process has been completed, thereby making it possible to monitor quality during the process with little temporal effort.

The process step of determining the quality criterion as a function of the acquired intensity and depth information can, for example, be configured in a computer-implemented manner, for example, via a processor. The intensity information may in particular be image data from a 2D camera. The depth information is in particular information about the topological position of a surface of the welded connection in a direction which is perpendicular to the plane of the acquisition area.

The conductor ends can, for example, be made of copper. The hairpin elements can, for example, be made of copper. The welded connection can, for example, be a copper-to-copper welded connection.

In an embodiment of the present invention, a first detection of the intensity information and the depth information can, for example, be carried out before the creation of the welded connection and a second detection of the intensity information and the depth information can, for example, be carried out after the creation of the welded connection, and the determination of the quality criterion can, for example, be carried out as a function of the intensity information and depth information determined before and after the creation of the welded connection. By determining the quality criterion as a function of the information acquired before and after welding, the quality criterion can be determined with improved accuracy. It is thereby advantageous if, in addition to the second recording of the intensity information and the depth information, the intensities of the process emissions are recorded after the welded joint has been created. The process emissions can in particular be recorded using detectors based on photodiodes for process-typical wavelengths.

In an embodiment of the present invention, the depth information can, for example, be determined via a triangulation device. The triangulation device can make an optical distance measurement possible and thereby provide depth information for the image points of the acquisition area. The triangulation device can, for example, be configured as a laser triangulation device. The laser triangulation device can comprise one or more line lasers.

An alternative embodiment of the present invention provides that the depth information can, for example, be determined via a device for optical coherence tomography or a grazing light device or a stereo camera.

In an embodiment of the present invention, the intensity information can, for example, be captured via an intensity channel. The intensity information can thereby define a greyscale image of the acquisition area. It is alternatively possible to acquire the intensity information using several, in particular three, intensity channels for different colors. The intensity information can in this case define several greyscale images for different colors which in combination show a colored image of the acquisition area. Intensity channels can, for example, be provided for the colors red, yellow and blue.

In an embodiment of the present invention, the quality criterion can, for example, be determined via a regression analysis. The regression analysis can be carried out via statistical analysis methods.

In an embodiment of the present invention, the quality criterion can, for example, be determined via a machine learning system. The machine learning system can, for example, be configured as an artificial neural network.

The present invention also provides a method for providing a training data set for a machine learning system for determining a quality criterion of a welded connection between two conductor ends, wherein intensity information of the image points and depth information of the image points are acquired for a plurality of image points of an acquisition area covering the conductor ends.

The present invention also provides a training data set for a machine learning model for determining a quality criterion of a welded connection between two conductor ends, the training data set comprising intensity information from a plurality of image points of an acquisition area encompassing the conductor ends and depth information of the image points. Information from time series, defined from the intensities of the process emissions, can also be provided.

The present invention also provides a method for welding conductor ends, in particular hairpin elements of an electric machine, using a beam welding process, in particular a laser welding process, wherein,
before welding a first pair of conductor ends, intensity information of the image points and depth information of the image points are acquired for a plurality of image points of an acquisition area covering the conductor ends,
the conductor ends of the first pair are welded,
after the welding of the first pair of conductor ends, intensity information of the image points and depth information of the image points are acquired for a plurality of image points of an acquisition area covering the conductor ends,
a quality criterion, in particular a connection area or a pore volume, is determined as a function of the acquired process emission intensity information, the intensity information of the image points and the depth information, and
the welding of a second pair of conductor ends, which follows the first pair, is controlled as a function of the determined quality criterion. The intensities of the process emissions can in this case, for example, be recorded during the welding.

The method makes it possible to test welded connections between conductor ends with little temporal effort and to stop the production of subsequent welded connections depending on the test results.

The embodiments and features explained in connection with the method for determining a quality criterion of a welded connection between two conductor ends can also be used, alone or in combination, in the method for welding conductor ends.

Further details and advantages of the present invention will be described below with reference to an embodiment as shown in the drawings.

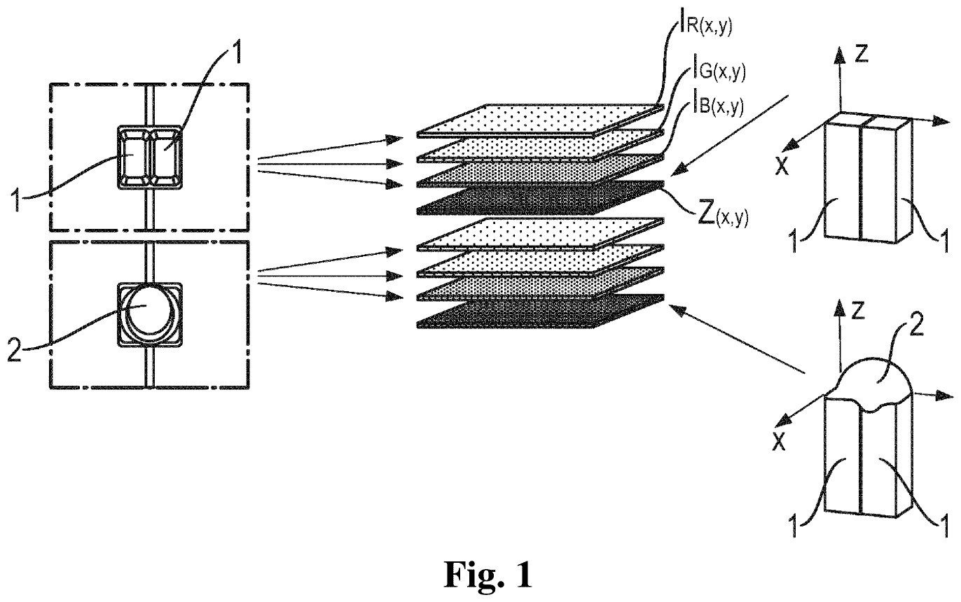

FIG. 1 schematically shows a sequence of an embodiment of a method according to the present invention for determining a quality criterion of a welded connection between two conductor ends 1. The conductor ends 1 shown here are conductor ends 1 of hairpin elements of an electric machine.

The images on the left show intensity information IR(x,y), IG(x,y), IB(x,y) from image points of an acquisition area that covers the conductor ends 1. The intensity information IR(x,y), IG(x,y), IB(x,y) in the upper representation was acquired before the welded connection was created and the intensity information IR(x,y), IG(x,y), IB(x,y) in the lower representation was acquired after the welded connection 2 was created. The intensity information IR(x,y), IG(x,y), IB(x,y) can be acquired by an image acquisition device, for example, an optical camera. According to the embodiment, the intensity information IR(x,y), IG(x,y), IB(x,y) has been acquired with several, in this case three, intensity channels. These may correspond, for example, to the intensity of the colors red, yellow and blue in the acquisition area.

In this acquisition area, depth information Z(x,y) of the image points was also acquired for the image points in addition to the intensity information IR(x,y), IG(x,y), IB(x,y). The depth information Z(x,y) can be acquired via a depth information acquisition device. This can, for example, be designed as a triangulation device, in particular as a laser triangulation device. A depth information detection device can alternatively be used that is configured as a device for optical coherence tomography or a grazing light device or a stereo camera.

According to the present invention, it is intended that a quality criterion, in particular a connection area or a pore volume of the welded joint 2, be determined as a function of the acquired intensity information IR(x,y), IG(x,y), IB(x,y) and depth information Z(x,y). The quality criterion is determined via a regression analysis. The determination of the quality criterion via a machine learning system 3 can, for example, be used.

The illustration in FIG. 2 shows a machine learning system 3 which is configured as an artificial neural network. To train the artificial neural network, a training data set 4 is supplied which includes intensity information from several image points of an acquisition area encompassing the conductor ends and depth information of the image points. The training data set 4 contains the information necessary for the monitored training of a model about the basic truth, the so-called ‘ground truth’, for example, the connection cross-section and the number of pores and their volume. The training data set 4 contains both the intensity and depth information acquired before the creation of the welded connection, as well as the intensity and depth information acquired after the creation of the welded connection. Training data set 4 according to FIG. 2 comprises intensity information with three channels.

The trained machine learning system 3 is used in the method for determining the quality criterion to determine the quality criterion of welded joint 2 based on the acquired intensity and depth information. The method can be carried out during the actual welding process or shortly after the welding process has been completed, thereby making it possible to monitor quality during the process with little temporal effort.

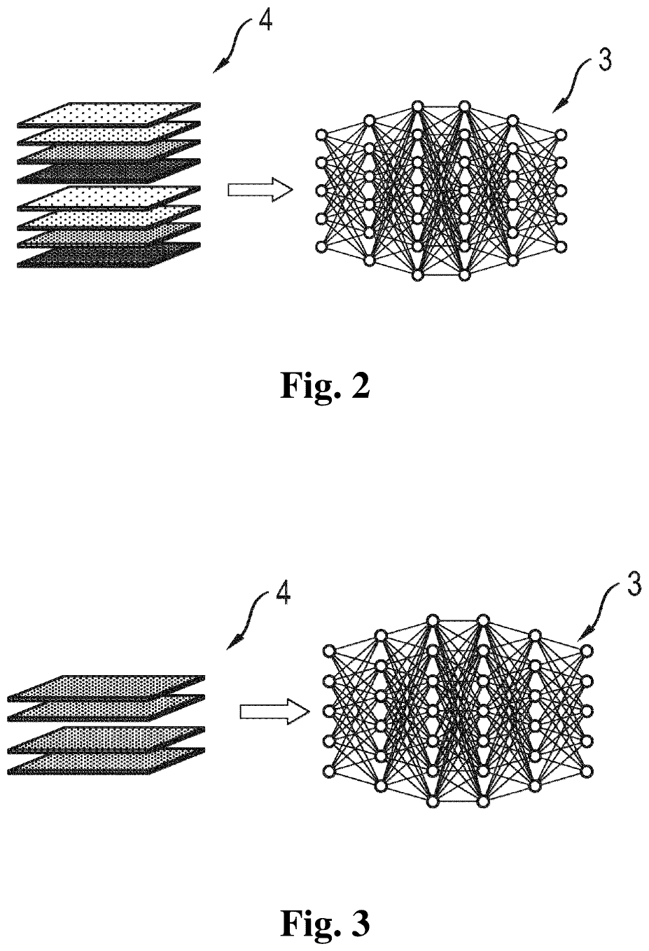

FIG. 3 shows a further machine learning system 3 which is configured as an artificial neural network. In contrast to the embodiment shown in FIG. 2, the training data set 4 here includes intensity information with exactly one intensity channel.

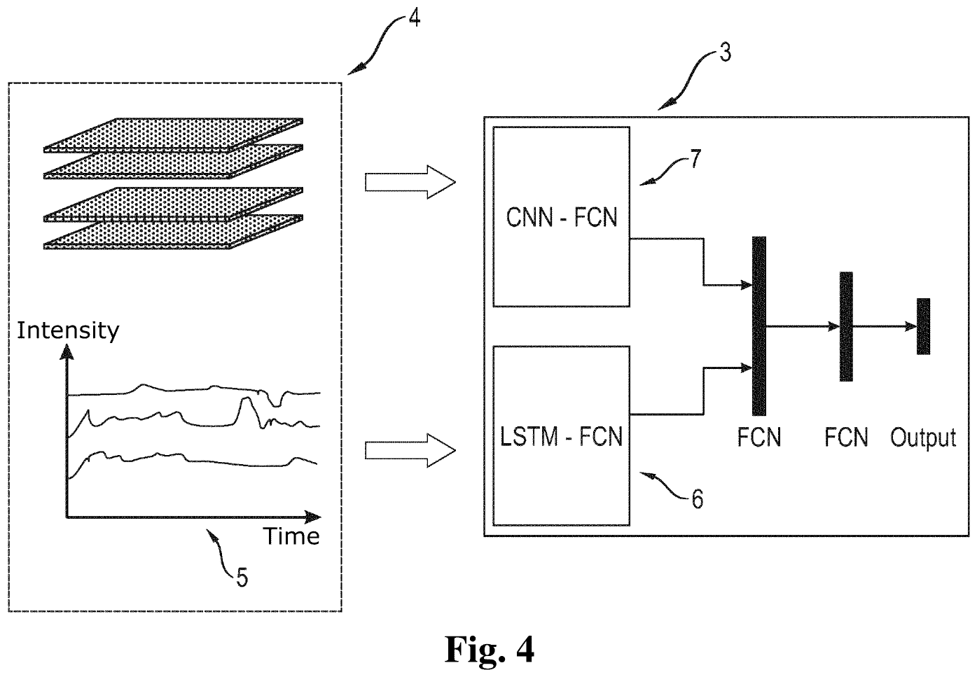

FIG. 4 shows a further machine learning system 3 which is configured as an artificial neural network and which is composed of network 6, consisting of LSTM and FCN layers, and network 7, consisting of CNN and FCN.

In contrast to the embodiment shown in FIG. 2, the training data set includes 4 intensity information with, for example, an intensity channel, depth information and time series consisting of the intensities of the process emissions. As an example, three time series are shown corresponding to the intensities at three selected wavelengths 5. The model to be trained is configured so that it comprises a branch which is specifically designed for time series regression based, for example, on an LSTM-FCN (neural network consisting of long short-term memory layers and fully connected layers), and a branch for image regression based, for example, on a CNN-PCN (convolutional layers and fully connected layers). Both branches are merged at the so-called feature layer.

The present invention is not limited to embodiments described herein; reference should be had to the appended claims.

### LIST OF REFERENCE NUMERALS

1 Conductor ends
2 Welded connection
3 Machine learning system
4 Training data set
5 Wavelengths
6 Network
7 Network
IR(x,y) Intensity information
IG(x,y) Intensity information
IB(x,y) Intensity information
Z(x,y) Depth information

What is claimed is:

1-15. (canceled)

16. A method for determining a quality criterion of a welded connection between two conductor ends, the method comprising:
acquiring intensity information of a plurality of image points and depth information of the plurality of image points of an acquisition area covering the two conductor ends; and
determining a quality criterion as a function of the intensity information acquired and the depth information acquired.

17. The method as recited in claim 16, wherein,
the two conductor ends are two conductor ends of hairpin elements of an electric machine, and
the quality criterion is a connection area or a pore volume.

18. The method according to claim 16, wherein,
the acquiring of the intensity information of the plurality image points and the acquiring of the depth information of the plurality of image points of the acquisition area covering the two conductor ends comprises,
a first acquisition of the intensity information and the depth information before a creation of the welded connection, and
a second acquisition of the intensity information and the depth information after the creation of the welded connection; and
the determining of the quality criterion as the function of the intensity information acquired and depth information acquired occurs before and after the creation of the welded connection.

19. The method according to claim 18, further comprising:
detecting an intensity of process emissions after the creation of the welded connection.

20. The method as recited in claim 16, wherein the depth information is determined via a triangulation device,

21. The method as recited in claim 20, wherein the triangulation device is a laser triangulation device.

22. The method as recited in claim 16, wherein the depth information is determined via a device for optical coherence tomography, via a grazing light device, or via a stereo camera.

23. The method as recited in claim 16, wherein the intensity information is detected with one intensity channel or with more than one intensity channel for different colors.

24. The method as recited in claim 23, wherein the more than one intensity channel for different colors is three intensity channels for different colors.

25. The method as recited in claim 16, wherein the determining of the quality criterion is performed via a regression analysis.

26. The method as recited in claim 16, wherein the determining of the quality criterion is performed via a machine learning system.

27. A method for providing a training data set for a machine learning system for determining a quality criterion of a welded connection between two conductor ends, the method comprising:
acquiring intensity information of a plurality of image points and depth information of the plurality of image points of an acquisition area encompassing the two conductor ends.

28. A training data set for a machine learning system for determining a quality criterion of a welded connection between two conductor ends, the training data set comprising:
intensity information of a plurality of image points of an acquisition area encompassing the two conductor ends; and
depth information of the plurality of image points.

29. The training data set as recited in claim 28, further comprising:
information from a time series,
wherein,
the time series is defined from intensities of process emissions.

30. A method for welding conductor ends using a beam welding process, the method comprising:
prior to welding a first pair of conductor ends, acquiring intensity information of a plurality of image points and depth information of the plurality of image points of an acquisition area covering the conductor ends;
welding the first pair of conductor ends;
after the welding of the first pair of conductor ends, acquiring intensity information of the plurality of image points and depth information of the plurality of image points of the acquisition area covering the conductor ends;
determining a quality criterion as a function of the intensity information acquired and the depth information acquired; and
after welding a second pair of conductor ends which is performed after the welding of the first pair of conductor ends, controlling the welding of the second pair of conductor ends as a function of the quality criterion determined.

31. The method as recited in claim 30, wherein,
the conductor ends are hairpin elements of an electric machine,
the beam welding process is a laser welding process, and
the quality criterion is a connection area or a pore volume.

32. The method as recited in claim 30, further comprising:
recording intensities of process emissions during the welding of the first pair of conductor ends, and
recording intensities of process emissions during the welding of the second pair of conductor ends.

33. A device for determining a quality criterion of a welded connection between two conductor ends, the device comprising:
an image-acquisition device which is configured to acquire intensity information for a plurality of image points of an acquisition area covering the two conductor ends;
a depth-information acquisition device which is configured to acquire depth information of the plurality of image points; and
a processor unit which is configured to determine a quality criterion as a function of the intensity information and depth information.

34. The device as recited in claim 33, wherein,
the two conductor ends are hairpin elements of an electric machine, and
the quality criterion is a connection area or a pore volume.

35. The device as recited in claim 33, further comprising:
a process radiation intensity detection unit.
